(19) United States
(12) Patent Application Publication
(10) Pub. No.: US 2010/0045732 A1
(43) Pub. Date: Feb. 25, 2010

(54) LIQUID EJECTING APPARATUS

(75) Inventors: Ryoji Fujimori, Suwa-shi (JP); Shigenori Fukasawa, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/542,932

(22) Filed: Aug. 18, 2009

(30) Foreign Application Priority Data
Aug. 19, 2008 (JP) 2008-210352
Aug. 20, 2008 (JP) 2008-211479

(51) Int. Cl. B41J 2/165

(52) U.S. Cl. 347/29

(57) ABSTRACT

A liquid ejecting apparatus for ejecting a liquid by using a liquid ejecting head provided with nozzles, includes: a cap capable of being mounted on the liquid ejecting head, wherein the cap includes a seal member which comes into close contact with the liquid ejecting head when the cap is mounted on the ejecting head, and the seal member is a member which is in a state where fluid is supplied in the interior thereof at least when the cap is mounted.

### CROSS REFERENCES TO RELATED APPLICATIONS

The entire disclosures of Japanese Patent Application Nos. 2008-210352 filed on Aug. 19, 2008 and 2008-211479 filed on Aug. 20, 2008 are expressly incorporated herein by reference.

### BACKGROUND

1. Technical Field

The present invention relates to the technology of ejecting a liquid from an ejecting head.

2. Related Art

Printers (so-called ink jet printers) which print an image by ejecting ink on a printing medium are widely used at present as an image output means because they can conveniently print a high quality image. Also, it is considered that by ejecting, instead of ink, various liquids (for example, a semi-liquid such as a liquid in which the fine particles of functional materials are dispersed, or a gel, and the like) prepared by proper ingredients on a substrate by applying this technology, it is also possible to conveniently manufacture various precision parts such as an electrode, a sensor, a biochip, and the like.

In this technology, a dedicated ejecting head provided with minute ejecting orifices is used to enable a precise quantity of liquid to be ejected at a precise position, and liquid supplied into the ejecting head is ejected out of the ejecting orifices. On the other hand, in order to eject precise quantity of the liquid at a precise position by sufficiently exerting the performance of the ejecting head, it is important that the nature of the liquid to be ejected is maintained falls within a predetermined allowable range. Thus, during the time when liquid is not ejected, in order to prevent changes in the nature of the liquid, a cap is mounted over the ejecting orifices. Since the cap is made from an elastic member, changes in the nature of the liquid are prevented by hermetically sealing the ejecting orifices by pressing the cap against the ejecting head (for example, referring to JP-A-2005-246640).

In this technology, however, there was a problem that the air-tightness in the cap could not be sufficiently increased. Namely, it is not easy to make the surface of the ejecting head completely flat and there are many cases where some wave-shaped uneven portions are produced in the surface. In such a case, when the elastic member of the cap has been pressed against the ejecting head, at the convex portion of the wave, the elastic member is greatly deformed, so that strong contact force is produced between the ejecting head and the cap. On the other hand, at a portion where the surface of the ejecting head becomes concave, the deformation amount of the elastic member is small, so that the contact force between the ejecting head and the cap is lowered. In this way, if even one place where the contact force is lowered is generated, it becomes difficult to secure air-tightness in the cap. Further, as described above, since it is practically impossible to make the surface of the ejecting head completely flat, it is considered that the above problem always exists.

### SUMMARY

An advantage of some aspects of the invention is that it provides the technology for enabling to increase the air-tightness of a cap by reliably bringing the cap into close contact with an ejecting head.

According to an aspect of the invention, there is provided a liquid ejecting apparatus for ejecting liquid by using a liquid ejecting head provided with nozzles, including: a cap capable of being mounted on the liquid ejecting head, wherein the cap includes a seal member which comes into close contact with the liquid ejecting head when the cap is mounted on the ejecting head, and the seal member is a member which is in a state where fluid is supplied in the interior thereof at least when the cap is mounted.

In the liquid ejecting apparatus according to the invention, when the cap is mounted on the liquid ejecting head, the seal member is interposed between the cap and the liquid ejecting head. A hollow is provided inside the seal member, and in a state in which fluid is fed in the hollow, the seal member is interposed between the liquid ejecting head and the cap.

In this case, the seal member is pressed against the liquid ejecting head or the cap by the pressure of the fluid in the interior thereof. Then, since the pressure of the fluid has the nature of acting perpendicularly to the surface of the fluid, even if the wave-shaped portions are formed in the surface of the liquid ejecting head, the seal member can be pressed perpendicularly to the surface of the liquid ejecting head. Also, the pressure of the fluid has the nature of acting with the same magnitude at any portion of the fluid, which is known as the so-called Pascal's principle. Therefore, even at the concave portion of the wave, the seal member can be reliably pressed against the surface of the liquid ejecting head without the lowering of the force pressing against the seal member. Accordingly, the seal member can be reliably brought into close contact with the surface of the liquid ejecting head, and consequently, the air-tightness of the cap is increased, so that the liquid ejecting nozzles can be reliably sealed.

Of course, since the pressure of the fluid equally acts on not only the liquid ejecting head but also the cap, the seal member can also be reliably brought into close contact with the cap. Accordingly, the air-tightness between the seal member and the cap is increased, so that the air-tightness of the cap can be further improved.

Also, the expression “a state where fluid is supplied in the interior of the seal member” as mentioned is used to mean not only a state in which fluid is supplied into the interior of the seal member when the cap is mounted, but also a state in which fluid has been supplied (or filled) in the interior of the seal member in advance before the cap is mounted.

Also, as fluid in the seal member, either an incompressible fluid (a semi-fluid such as a gel, a liquid, or the like), whose volume is not changed so much even when pressure is applied, or a compressible fluid (for example, a gas such as air), whose volume is changed by pressure, may be used. In a case where an incompressible fluid is used, a high repulsive force is obtained only by slightly pressing down the fluid, so that high contact force can be obtained even without greatly crushing the seal member. On the other hand, when the compressible fluid is used, even if the force used to mount the cap on the liquid ejecting head is too strong, the force can be absorbed by compression of the fluid, so that it becomes possible to avoid concerns that the liquid ejecting head or the cap will be broken by a strong applied force.

Also, in the above-described liquid ejecting apparatus according to the invention, the configuration is arranged such that fluid is supplied (or filled) in the interior of the seal member in advance, and then the seal member is interposed between the liquid ejecting head and the cap. However, the configuration may also be arranged such that fluid is supplied into the interior of the seal member at the timing of mounting the cap.

Since it is also conceivable that fluid in the seal member is vaporized or leaked out of the seal member little by little, there are concerns that after the lapsing of a long period of time, the pressure of the fluid in the seal member is lowered, and thus the contact force of the seal member is lowered. So, if fluid is supplied into the seal member at the timing of mounting the cap, it is possible to mount the cap in a state where the pressure of the fluid is increased, so that the seal member can be reliably brought into close contact with the liquid ejecting head or the cap.

Further, if fluid is supplied into the seal member, the seal member can be expanded. Therefore, the cap can be brought into contact with the liquid ejecting head via the expanded seal member even without greatly driving the cap. Accordingly, it becomes also possible to further simplify the driving mechanism of the cap.

Also, in the above-described liquid ejecting apparatus according to the invention, the configuration may also be arranged such that when the cap is detached, fluid in the seal member is discharged.

With this configuration, even in the case where the seal member has been stuck to the liquid ejecting head, the seal member can be easily detached from the liquid ejecting head by discharging the fluid, and thus shrinking the seal member. Therefore, the cap can be easily detached, and then the ejecting of the liquid can be quickly started.

Further, in the above-described liquid ejecting apparatus according to the invention, the configuration may also be arranged such that a waste liquid tank for collecting liquid discharged from the ejecting nozzles is prepared, and then the liquid collected in the waste liquid tank is supplied into the seal member.

If liquid discharged from the ejecting nozzles is collected in the waste liquid tank, and then supplied into the seal member, fluid for the seal member does not need to be prepared separately, so that it becomes possible to further simplify the configuration of the apparatus. Further, if liquid discharged from the ejecting nozzles is used, new liquid does not need to be consumed, and thus it becomes also possible to suppress the amount of liquid consumed.

Further, in the above-described liquid ejecting apparatus according to the invention, the configuration may be arranged as follow. First, a liquid tank is connected to the liquid ejecting head, and then, liquid in the liquid tank is pressurized by a pressurizing pump so that liquid is supplied into the liquid ejecting head. Also, the interior of the seal member is connected to a fluid reservoir in which the fluid has been stored. Then, by exerting the pressure produced by the pressurizing pump on the fluid reservoir, fluid is supplied into the seal member.

It is preferable if pressure is applied to liquid in the liquid tank by the pressurizing pump, liquid can be efficiently sent to the liquid ejecting head by the pressure. On the other hand, if the pressure produced by the pressurizing pump is exerted on the fluid reservoir, fluid in the fluid reservoir is sent to the seal member by the pressure, so that it becomes possible to supply fluid into the seal member. With this configuration, since a mechanism for supplying fluid into the seal member does not need to be provided separately, it becomes possible to simplify the configuration of the apparatus.

Further, in terms of the aspect of exerting the pressure from the pressurizing pump on the fluid reservoir, the pressure may be exerted directly on fluid in the fluid reservoir, or alternatively, may also be exerted indirectly through any other medium such as air. For example, by exerting pressure on air in the fluid reservoir, pressure may be exerted on the fluid in the fluid reservoir, or by applying pressure to the outer wall of the fluid reservoir, pressure may also be exerted on the fluid. Also in this case, since fluid can be delivered from the fluid reservoir, fluid can be supplied into the seal member.

Further, in the liquid ejecting apparatus according to the invention, in terms of increasing the air-tightness between the cap and the liquid ejecting head by the seal member with fluid supplied in the interior thereof when the cap is mounted on the liquid ejecting head, if the seal member is interposed between the cap and the liquid ejecting head, it is sufficient and there is no need to provide the seal member on the cap side. Therefore, the liquid ejecting apparatus according to the invention may also be understood as an aspect described below.

The liquid ejecting apparatus according to this aspect of the invention may also be understood as a liquid ejecting apparatus for ejecting liquid by using a liquid ejecting head provided with nozzles, including a cap capable of being mounted on the liquid ejecting head, wherein the cap includes a seal member which is interposed between the cap and the liquid ejecting head when the cap has been mounted on the liquid ejecting head, and the seal member is a member which is in a state where fluid is supplied in the interior thereof at least when the cap is mounted.

In the liquid ejecting apparatus according to this aspect, when the cap is mounted on the liquid ejecting head, the seal member is interposed between the cap and the liquid ejecting head. A hollow is provided inside the seal member, and in a state in which fluid is fed in the hollow, the seal member is interposed between the liquid ejecting head and the cap.

With this configuration, the seal member interposed between the liquid ejecting head and the cap is pressed against the liquid ejecting head or the cap by the pressure of the fluid in the interior thereof. In this state, regardless of whether the seal member is provided on the cap side or the liquid ejecting head side, by the same mechanism as that of the above-described liquid ejecting apparatus according to the invention, it becomes possible to increase the air-tightness of the cap, thereby ensure the ejecting nozzles are in a sealed state. Namely, since the pressure of the fluid acts perpendicularly to the surface of the fluid, even if the wave-shaped portions are formed in the surface of the liquid ejecting head, it becomes possible to press the seal member perpendicularly to the surface of the liquid ejecting head. Also, since the pressure of the fluid has the nature of acting with the same magnitude at any portion of the fluid, even at the concave portion of the wave, the seal member can be reliably brought into close contact with the surface of the liquid ejecting head without the lowering of the force pressing the seal member.

Of course, since the pressure of the fluid equally acts on not only the liquid ejecting head but also the cap, the seal member can also be reliably brought into close contact with the cap. Accordingly, the air-tightness between the seal member and the cap is increased, so that the air-tightness of the cap can be further improved.

Also, in the liquid ejecting apparatus according to the above aspect, the seal member may also be provided separately from the cap and the liquid ejecting head. Also in this case, when the cap is mounted on the liquid ejecting head, if the seal member is interposed between them, it becomes possible to ensure the liquid ejecting head is in a sealed state by the above-described mechanism.

Also in the liquid ejecting apparatus according to the above aspect, as the fluid in the seal member, various fluids including incompressible fluids such as semi-fluid such as gel, or liquid, and compressible fluids such as air can be used.

Also, according to another aspect of the invention, there is provided a liquid ejecting apparatus for ejecting liquid by using a liquid ejecting head provided with nozzles, including a cap capable of being mounted on the liquid ejecting head, the apparatus further including: a seal member disposed on the side of the cap facing the liquid ejecting head; a fluid feeder which supplies fluid into the seal member so that the seal member is in a state where fluid is supplied in the interior thereof at least when the cap is mounted; and a regulating member which is provided on the cap on the side of the seal member disposed on the cap so as to regulate the intrusion of the seal member.

In the liquid ejecting apparatus according to this aspect, the seal member is provided on the cap, and when the cap is mounted on the liquid ejecting head, the seal member is interposed between the cap and the liquid ejecting head. A hollow is provided inside the seal member, and at least when the cap is mounted on the liquid ejecting head, the seal member is in a state in which fluid is fed in the hollow therein. Further, the regulating member for regulating the intrusion of the seal member is provided on the side of the seal member disposed on the cap.

With this configuration, when the cap has been mounted on the liquid ejecting head, the seal member is in a state in which it is interposed between the cap and the liquid ejecting head, and also in a state in which fluid is supplied in the hollow formed inside the seal member. Therefore, the seal member is pressed against the liquid ejecting head by the pressure of fluid in the hollow. In general, since the pressure of fluid has the nature of acting perpendicularly to the surface, even if wave-shaped portions are formed in the surface of the liquid ejecting head, it becomes possible to press the seal member perpendicularly to the surface of the liquid ejecting head. Also, according to the teaching of the so-called Pascal's principle, the pressure of the fluid acts with the same magnitude at any portion of the fluid. Therefore, even at the concave portion of the wave, the seal member can be reliably pressed against the surface of the liquid ejecting head without the lowering of the force pressing the seal member. Therefore, the seal member can be reliably brought into close contact with the surface of the liquid ejecting head, and consequently the air-tightness of the cap is increased, so that the ejecting nozzles can be reliably sealed.

Further, if the regulating member is provided on the side of the seal member disposed on the cap, even if the seal member has become droopy due to the lowering of the pressure of the fluid in the seal member, the laterally spreading out of the seal member can be regulated by the regulating member. Therefore, it becomes possible to avoid a situation in which the seal member interferes with the peripheral members or apparatuses, and consequently it becomes possible to avoid disadvantages such as contamination of the surrounding members with fluid adhered to the seal member and an impediment to the peripheral apparatuses due to the sticking of the seal member to the apparatus.

Also, as fluid supplied into the seal member, either an incompressible fluid (a semi-fluid such as a gel, a liquid, or the like), whose volume is not changed so much even when pressure is applied, or a compressible fluid (for example, a gas such as air), whose volume is changed by pressure, may be used. In a case where an incompressible fluid has been used, since a high repulsive force is obtained only by slightly pressing down the fluid, high contact force can be obtained even without greatly crushing the seal member. On the other hand, when the compressible fluid is used, even if the force used in mounting the cap on the liquid ejecting head is too strong, the force can be absorbed by the compression of the fluid, so that it becomes possible to avoid concerns that the liquid ejecting head or the cap is broken by the application of a strong force.

Also, in the above-described liquid ejecting apparatus according to the invention, the regulating member may be provided inside the place where the seal member is disposed on the cap.

With this configuration, since the entering of the seal member into the cap can be regulated, it becomes possible to avoid a situation in which the seal member is contaminated with the ink in the cap.

Also, in the above-described liquid ejecting apparatus according to the invention, the regulating member may also be provided outside the place where the seal member is disposed on the cap.

With this configuration, since the spreading of the seal member outside the cap can be regulated, it becomes possible to avoid a situation in which the seal member with the fluid attached comes into contact with the member at the periphery of the cap, and the like, thereby contaminating the surroundings.

Also, in the above-described liquid ejecting apparatus according to the invention, the regulating members may also be provided in parallel on both sides of the seal member, and then the seal member may be provided to span between these regulating members.

With this configuration, when the seal member has drooped, the seal member is drawn down by either its own weight or the fluid, so that it is positioned between the regulating members. Therefore, even if the seal member has drooped greatly, the seal member can be reliably held between the regulating members. Accordingly, it becomes possible to avoid a situation in which the seal member contaminates the surroundings or interferes with the peripheral members.

Also, in the above-described liquid ejecting apparatus according to the invention, the seal member and the regulating member may also be integrally formed.

With this configuration, since the regulating member does not need to be provided separately from the seal member, it becomes possible to simplify the configuration of the cap.

### BRIEF DESCRIPTION OF THE DRAWINGS

The invention will be described with reference to the accompanying drawings, wherein like numbers reference like elements.

FIG. 1 is an explanatory view illustrating the general configuration of a liquid ejecting apparatus according to an embodiment of the invention by using an ink jet printer as an example.

FIG. 2 is an explanatory view generally illustrating a maintenance mechanism of the ink jet printer according to the embodiment.

FIGS. 3A to 3C are explanatory views illustrating a capping unit according to the embodiment.

FIGS. 4A and 4B are explanatory views conceptually illustrating an aspect when the capping unit according to the embodiment is brought into close contact with the surface of an ejecting head.

FIGS. 5A and 5B are explanatory views illustrating a capping unit according to a modified example, in which the fluid in a fluid bag can go in and out.

FIGS. 6A to 6C are explanatory views illustrating a capping unit according to another modified example.

FIG. 7 is an explanatory view illustrating an aspect of using a guard member to prevent the situation in which a fluid bag enters a cap.

FIG. 8 is an explanatory view illustrating a capping unit in which guard members are provided on both sides of a fluid bag.

FIG. 9 is an explanatory view illustrating a capping unit according to a modified example in which one side face of a fluid bag is adhered to one side face of a guard member.

FIG. 10 is an explanatory view illustrating a capping unit having a guard member provided by the thickening of a portion of a fluid bag.

FIGS. 11A and 11B are explanatory views illustrating a capping unit according to a modified example in which a fluid bag is provided on a guard member.

FIGS. 12A and 12B are explanatory views illustrating a capping unit according to a modified example constituted such that a fluid bag can be housed in a cavity of a cap member.

FIG. 13 is an explanatory view illustrating a capping unit according to a modified example in which a fluid bag is provided on the surface of the ejecting head.

FIG. 14 is an explanatory view illustrating a modified example in which the fluid bag is not fixed to either of the cap member and the ejecting head.

### DESCRIPTION OF EXEMPLARY EMBODIMENTS

Hereinafter, in order to clarify the above-described contents of the invention, an embodiment and modified examples will be explained in the following order:

A. Configuration of Apparatus

B. Capping Unit according to an Embodiment

C. Modified Examples
C-1. First Modified Example
C-2. Second Modified Example
C-3. Third Modified Example
C-4. Fourth Modified Example
C-5. Fifth Modified Example
C-6. Sixth Modified Example

### Configuration of Apparatus

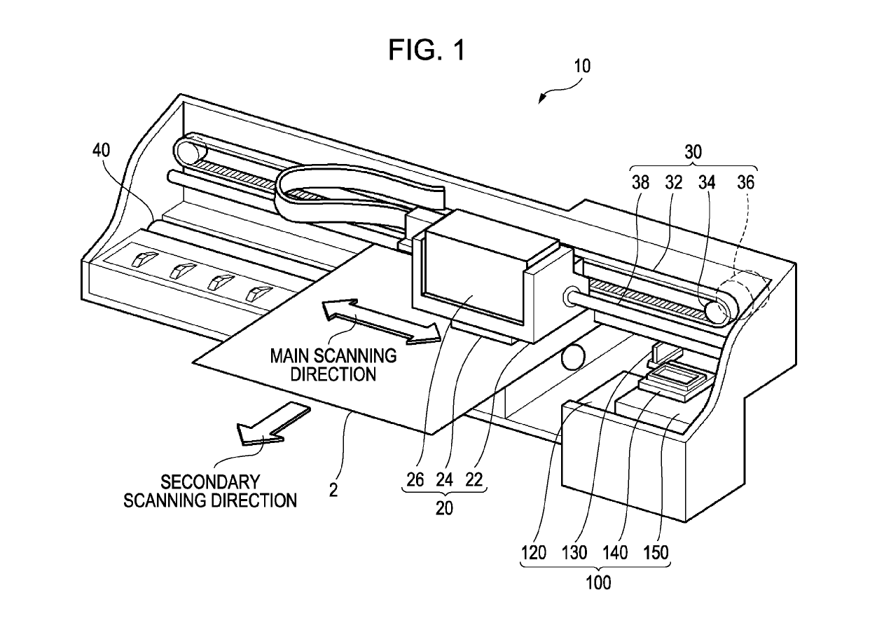

FIG. 1 is an explanatory view illustrating the general configuration of a liquid ejecting apparatus according to an embodiment of the invention by using a so-called ink jet printer as an example. As shown in the drawing, the ink jet printer 10 includes: a carriage 20 for producing ink dots on a printing medium 2 while reciprocating in a main scanning direction; a driving mechanism 30 for reciprocating the carriage 20; a platen roller 40 for performing the feeding of the printing medium 2; a maintenance mechanism 100 for performing maintenance so as to enable normal printing to be executed; and the like. The carriage 20 includes an ink cartridge 26 for containing ink, a carriage case 22 on which the ink cartridge 26 is mounted, an ejecting head 24 as the liquid ejecting head, which is mounted on the bottom side (side facing the printing medium 2) of the carriage case 22 so as to eject the ink, and the like, and operates to introduce the ink in the ink cartridge 26 into the ejecting head 24 and eject the correct quantity of ink from the ejecting head 24 on the printing medium 2, so that an image is printed.

The driving mechanism 30 for reciprocating the carriage 20 includes a guide rail 38 extending in the main scanning direction, a timing belt 32 with a plurality of teeth formed at its inner side, a driving pulley 34 having teeth engaged with the teeth of the timing belt 32, a step motor 36 for driving the driving pulley 34, and the like. A portion of the timing belt 32 is fixed to the carriage case 22, which can be moved along the guide rail 38 by driving the timing belt 32. Also, since the teeth of the timing belt 32 and the driving pulley 34 are engaged with each other, if the driving pulley 34 is driven by the step motor 36, the carriage case 22 can be moved with high precision in accordance with the driving amount.

The platen roller 40 for performing the feeding of the printing medium 2 is driven by a driving motor and a gear mechanism, which are not shown, and thus the printing medium 2 can be fed by a predetermined amount in a secondary scanning direction. The ink jet printer 10 continues to print an image on the printing medium 2 by driving the ejecting head 24 in the main scanning direction and ejecting the ink of each color from ejecting nozzles, while feeding the printing medium 2 in the secondary scanning direction by these mechanisms.

In this manner, in the ink jet printer 10 according to this embodiment, the image is printed by ejecting ink of each color from a plurality of ejecting nozzles provided at the ejecting head 24. First of all, in order to appropriately eject the ink from the ejecting nozzles, it is important that the nature of the ink in the ejecting nozzles be maintained in a suitable state, and if a changes occur in the nature of the ink (for example, thickening in viscosity) due to the evaporation of a volatile component of the ink, or the like, the ink cannot be normally ejected from the ejecting nozzles. For this reason, the ink jet printer 10 is provided with the maintenance mechanism 100 for maintaining a state capable of normally ejecting the ink, in addition to various mechanisms for printing the image.

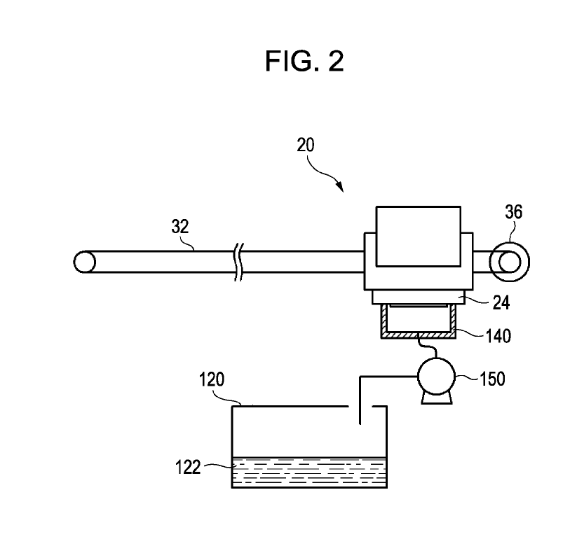

FIG. 2 is an explanatory view illustrating the general configuration of the maintenance mechanism 100. The maintenance mechanism 100 is provided at an area called a home position, other than a printing area (referring to FIG. 1), and includes a wiper blade 130 for wiping the surface of the ejecting head 24, a capping unit 140 pressed against the bottom surface of the ejecting head 24 to form an enclosed space between it and the ejecting head 24, a suction pump 150 connected to the enclosed space in the capping unit 140, and the like. Further, below the suction pump 150, there is provided a waste liquid tank 120. When printing is not being carried out, the carriage 20 is moved up to the home position, thereby pushing up the capping unit 140 to form the enclosed space on the bottom surface of the ejecting head 24. Although the minute ejecting nozzles for ejecting the ink are opened in the bottom surface of the ejecting head 24, the enclosed space thus formed makes it possible to prevent thickening in viscosity due to the drying of the ink in the ejecting head 24.

Also, even if the drying of the ink has been prevented by pressing the capping unit against the ejecting head 24, moisture or a volatile component in the ink can be reduced little by little over a long period, resulting in a change in the nature of the ink (for example, thickening in viscosity). Thus, in this case, an operation is carried out which involves sucking out the ink from the ejecting nozzles (cleaning operation) by making negative-pressure in the enclosed space by the operation of the suction pump 150 in a state in which the capping unit 140 is mounted. If the cleaning operation is performed, the ink whose nature has changed can be forcibly discharged from the ejecting nozzles, so that the ejecting nozzles can be restored to a normal state. In this manner, in the ink jet printer 10, by the maintenance mechanism 100, it becomes possible to prevent the evaporation of the ink or forcibly discharge the ink whose nature has changed, and therefore the ejecting head 24 can be maintained in a normal state.

First of all, as described above, wave-shaped uneven portions are formed in the surface of the ejecting head, so that there are cases where the capping unit cannot be brought into completely close contact with the surface of the ejecting head. In this case, since air-tightness in a cap is lowered, there are concerns that the ink in the ejecting head will dry up in a short time, or that in the cleaning operation, sufficient negative-pressure cannot be produced in the cap, so that the ink cannot be efficiently discharged. Therefore, in the ink jet printer 10 according to this embodiment, in order to enable an increase the air-tightness in the cap by reliably bring the capping unit into close contact with the ejecting head, the capping unit has the configuration as described below.

### Capping Unit According to an Embodiment

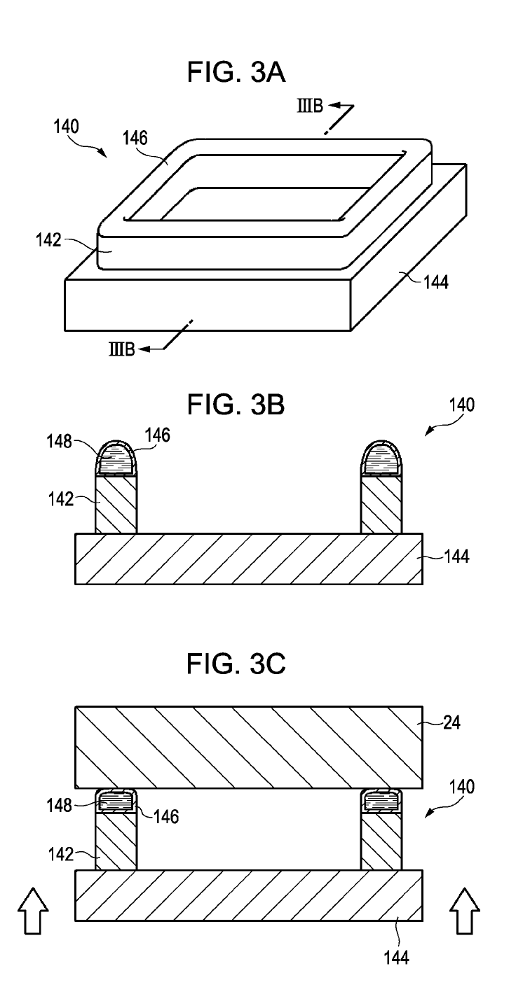

FIGS. 3A to 3C are explanatory views illustrating the capping unit 140 according to this embodiment. In FIG. 3A, a perspective view of the capping unit 140 is shown, and a cross-sectional view taken along line IIIB-IIIB of FIG. 3A is shown in FIG. 3B. As shown in these drawings, the capping unit 140 according to this embodiment is provided with a cap member 142 disposed in a rectangular shape on top of a capping plate 144, and in addition, a fluid bag 146 used as the seal member is disposed on the upper end of the cap member 142. As shown in FIG. 3B, the fluid bag 146 is of a tube structure made of a member of a thin membrane shape and is filled with a fluid 148. In the ink jet printer 10 according to this embodiment, the ejecting nozzles are sealed by pressing the capping unit 140 according to this embodiment against the ejecting head 24.

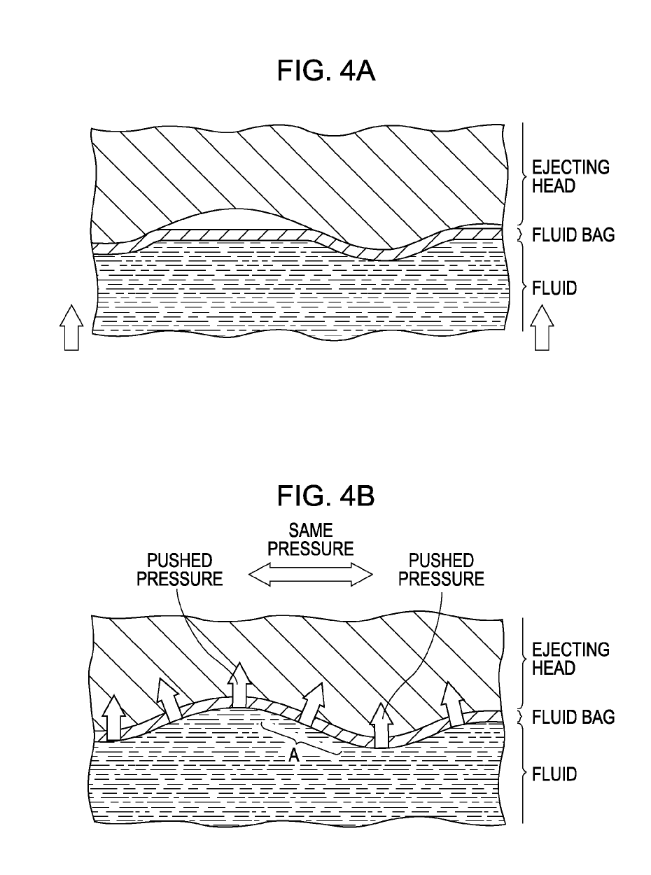

FIG. 3C is an explanatory view illustrating an aspect when the capping unit 140 according to this embodiment has been pressed against the ejecting head 24. In the capping unit 140 according to this embodiment, since the fluid bag is provided on the cap member 142, if the capping unit is pushed up toward the ejecting head 24, the fluid bag comes into contact with the surface of the ejecting head 24, as shown in the drawing. In this manner, in this embodiment, even if the uneven portions exist in the surface of the ejecting head 24, by pressing the capping unit 140 against the ejecting head 24 via the fluid bag 146, it is possible to maintain a high level of the air-tightness of the cap. With regard to this, description will be made in detail with reference to FIGS. 4A and 4B.

FIGS. 4A and 4B are explanatory views illustrating the aspect of the surface of the fluid bag when the capping unit is mounted. As shown in FIG. 4A, as the fluid bag 146 is pressed against the surface of the ejecting head 24, the fluid in the fluid bag is pressed down by the surface of the ejecting head 24, so that the shape of the fluid bag 146 varies along the surface of the ejecting head 24. Here, since the fluid can be freely varied in shape, when the fluid bag 146 is deformed, a strong repulsive force, such as with the elastic member, does not occur. For this reason, the fluid bag 146 can easily vary in shape to conform to the shape of the surface of the ejecting head 24. In this way, when the fluid bag 146 is deformed, and thus completely brought into close contact with the surface of the ejecting head 24, so that the shape of the fluid bag 146 cannot be varied no longer (referring to FIG. 4B), then, the fluid bag 146 is pressed against the ejecting head 24 by the pressure of the fluid itself (air pressure or liquid pressure).

FIG. 4B is an explanatory view conceptually illustrating an aspect when the fluid bag 146 is pressed against the ejecting head 24 by the pressure of the fluid. Here, the pressure of the fluid has a nature in which the pressures at all places in the fluid become equal, which is known as the so-called Pascal's principle. Therefore, as indicated by arrows in the drawing, the fluid bag 146 receives the same pressure at all places from the fluid, and consequently all places contacting with the ejecting head 24 are pressed against the ejecting head 24 with the same pressure. In a case where an elastic member such as rubber, instead of the fluid bag 146, has been pressed at a place where the surface of the ejecting head 24 is convex, the elastic member is greatly deformed so that strong contact force is obtained, whereas at a place where the surface of the ejecting head 24 becomes concave, the deformation amount of the elastic member is small, so that contact force becomes low. In this manner, in case of the elastic member, if the uneven portions exist in the surface of the ejecting head 24, it becomes difficult to obtain uniform contact force. However, as in this embodiment, in such a configuration that the fluid bag is pressed, the fluid bag is pressed against the ejecting head 24 with the same pressure by the fluid, so that a uniform contact force can be obtained. Therefore, also at the concave portion of the surface of the ejecting head 24, the fluid bag can be reliably brought into close contact with the surface of the ejecting head 24.

Also, the pressure of the fluid has the nature of acting perpendicularly to the surface of the fluid, and therefore even if the surface of the ejecting head 24 has a portion (portion indicated by symbol “A” in the drawing) which is inclined with respect to the direction in which the capping unit 140 is pushed up (vertical direction in the drawing), the fluid bag 146 can be vertically pressed against the surface of the ejecting head 24. Therefore, also at such a portion, the fluid bag 146 can be reliably brought into close contact with the surface of the ejecting head 24 without the lowering of contact force.

In this manner, in the capping unit 140 according to this embodiment, the fluid bag 146 is brought into close contact with the surface of the ejecting head 24 by the deformation of the bag, and at the same time, the fluid bag 146 is vertically pressed against the ejecting head 24 with uniform pressure. Therefore, even if the uneven portions exist in the surface of the ejecting head 24, the fluid bag 146 can be reliably brought into close contact with the surface of the ejecting head 24 without the occurrence of the portion with contact force lowered. Accordingly, it becomes possible to increase the air-tightness in the cap, thereby reliably sealing the ejecting nozzles.

Further, since at the concave portion of the surface of the ejecting head, the liquid surface of the fluid rises higher in comparison to the convex portion (referring to FIG. 4B), or more precisely, the pressure at the portion with a lower liquid surface becomes higher by the weight of the risen fluid. However, since the pressure resulting from such a difference in the heights of the liquid surface is small compared with the pressure of the fluid itself, practically, almost equal pressure is produced at both the convex portion and the concave portion. Therefore, even if such a difference in the heights of the liquid surface exists, the fluid bag can be reliably brought into close contact with the ejecting head.

Also, as described above, since the pressure of the fluid acts perpendicularly to the surface of the ejecting head 24, the capping unit 140 only needs to be pushed up straight up. Therefore, the driving mechanism of the capping unit 140 can be kept simple. Further, even if the capping unit 140 could not be pushed completely straight up, it is possible to vertically press the fluid bag 146 against the ejecting head 24 by the pressure of the fluid. Therefore, even if the capping unit 140 is driven somewhat obliquely or in a somewhat rattling manner, the contact force is not lowered. Accordingly, it is also possible to further simplify the driving mechanism of the capping unit. Further, since higher assembly accuracy is not required in the assembling of the driving mechanism, it is also possible to further simplify the manufacturing process.

Further, as the fluid to be filled in the fluid bag 146, either a liquid (incompressible fluid) such as water and oil or a gas (compressible fluid) such as air may be used. If a liquid is used, sufficient air-tightness can be obtained between the capping unit 140 and the ejecting head 24 only by slightly pressing the capping unit 140 against the ejecting head 24. On the other hand, if a gas is used, even in a case where the capping unit 140 is excessively pressed against the ejecting head 24 for any reason, the pushed force is alleviated by the compression of the gas, so that breakage of the capping unit 140 or the ejecting head 24 due to the applied excessive force can be avoid.

As described above, in the ink jet printer 10 according to this embodiment, the capping unit 140 is reliably brought into close contact with the ejecting head 24 with the fluid bag 146 interposed between the cap member 142 and the ejecting head 24, so that the air-tightness of the cap is increased. Thus, the vaporization of the ink from the ejecting nozzles can be reliably blocked, and consequently an image printable state can be maintained over a long period of time. Further, for this reason, the operation (cleaning operation) of sucking and discharging of ink whose nature has changed by using the suction pump 150 may not be performed frequently, so that the consumed amount of the ink can also be suppressed.

Further, even in the case where the ink cannot be normally ejected due to the thickening in viscosity of the ink, or the like, if the cleaning operation is performed, even the ink with thickened viscosity can be efficiently sucked because of the high air-tightness of the cap. Therefore, it becomes possible to quickly restore the ejecting head 24 to a normal state, and also it becomes possible to quickly start the printing of an image by rapidly completing the cleaning operation. In this manner, in the ink jet printer 10 according to this embodiment, by interposing the fluid bag between the cap and the ejecting head, a printable state can be maintained over a long period of time, and also, the ejecting head can be quickly restored to a normally printable state, so that a high quality image can be quickly printed.

### MODIFIED EXAMPLES

In the embodiment described above, some modified examples are conceivable. Hereinafter, these modified examples will be described briefly.

### First Modified Example

The above embodiment has been described as a case where the fluid bag is always filled with a fluid. However, a configuration may be provided in which the fluid can be fed into or discharged from the fluid bag as needed, but not so the fluid bag is always kept filled with the fluid.

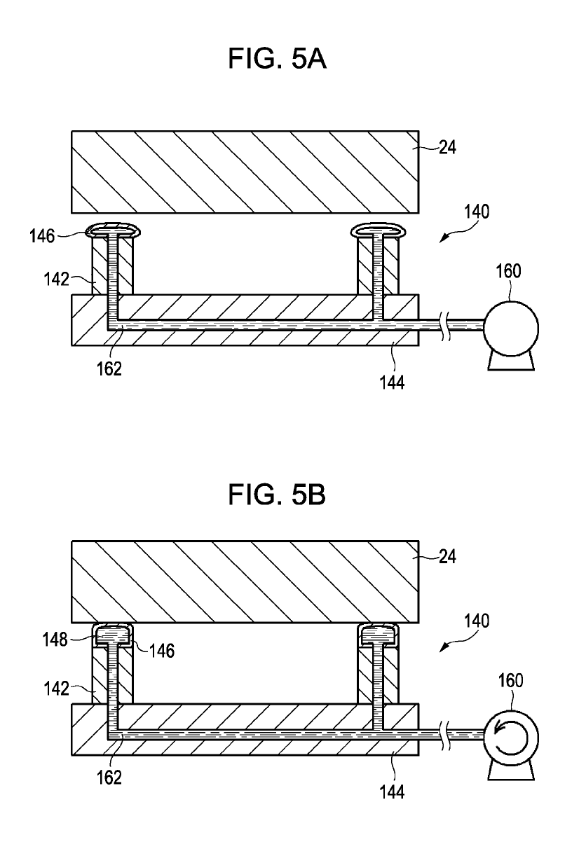

FIGS. 5A and 5B are explanatory views illustrating a modified example constituted such that the fluid can be fed into or discharged from the fluid bag. As shown in FIG. 5A, the fluid bag 146 is connected to a flow path 162, which passes through the insides of the cap member 142 and capping plate 144 and is connected to a fluid driving pump 160 which is the fluid feeder. Then, the feeding or the discharging of the fluid into or from the fluid bag 146 can be carried out by the driving of the fluid driving pump 160. When the capping unit 140 is mounted, the fluid is introduced into the fluid bag 146 by driving the fluid driving pump 160, thereby making a state in which the fluid bag 146 is filled with the fluid. In this state, if the capping unit 140 is pressed against the ejecting head 24 (referring to FIG. 5B) as described above, the fluid bag 146 can be reliably brought into close contact with the surface of the ejecting head 24 by the pressure of the fluid, so that the air-tightness of the cap can be increased, whereby it becomes possible to reliably seal the ejecting nozzles.

On the other hand, when the capping unit 140 is detached from the ejecting head 24, the fluid in the fluid bag 146 is discharged by driving the fluid driving pump 160. Thus, the fluid bag 146 shrinks, so that it falls off from the surface of the ejecting head 24. Therefore, even in the case where the fluid bag 146 has been stuck to the surface of the ejecting head 24, the fluid bag 146 can be easily removed, so that the capping unit 140 can be quickly detached. At this time, the fluid driving pump 160 functions as a fluid discharger.

Further, in the capping unit 140 according to this modified example, it is possible to bring the upper surface of the fluid bag 146 into contact with the ejecting head 24 by injecting fluid into the fluid bag 146, and to the contrary, it is possible to separate the fluid bag 146 from the ejecting head 24 by discharging fluid from the fluid bag. Therefore, when the capping unit 140 is mounted or detached, the capping unit 140 itself does not need to be greatly moved up or down. Therefore, it becomes also possible to simplify the driving mechanism of the capping unit 140. Further, if the fluid bag 146 has been expanded even more, the fluid bag 146 can be mounted on or detached from the ejecting head 24 with hardly driving the capping unit 140 itself, so that it becomes also possible to further simplify the configuration of the apparatus by omitting the driving mechanism of the capping unit 140.

Further, by changing the electric power supplied to the fluid driving pump 160 or the driving time of the fluid driving pump 160, it is also possible to change the pressure of fluid supplied into the fluid bag 146 (pressure of the fluid in the fluid bag 146). Accordingly, the contact force between the fluid bag 146 and the ejecting head 24 can be controlled, so that the fluid bag 146 can be brought into close contact with the ejecting head 24 by a more suitable force depending on the situation. For example, when the ejecting nozzles are to be sealed over for a long period of time, it is possible to make the sealing higher by increasing the pressure of the fluid. In the contrary, in cases when the required sealing time is short (for example, a case where the platen roller 40 waits for the transportation of the next printing paper during the printing of plural pages), if a state is kept in which the pressure of the fluid is not increased so much, the capping unit 140 can be quickly mounted or detached, so that it becomes possible to immediately return to a printing operation.

Further, as the fluid to be injected into the fluid bag 146, waste ink discharged by the cleaning operation or the like may also be utilized. Since the waste ink is contained in the waste liquid tank 120, by using the configuration to inject the waste ink by the fluid driving pump 160, fluid does not need to be stored separately, so that it becomes possible to further simplify the configuration of the apparatus.

Further, the fluid may be injected also by utilizing the suction pump 150, which is used in the cleaning operation, instead of the fluid driving pump 160. Otherwise, in a general ink jet printer, there is a case where the printer is provided with a pressurizing pump for feeding the ink into the ejecting nozzles, and therefore, in such a case, the pressurizing pump may also be used. Therefore, there is no need to separately provide the fluid driving pump 160, so that it becomes possible to further simplify the configuration of the apparatus.

### Second Modified Example

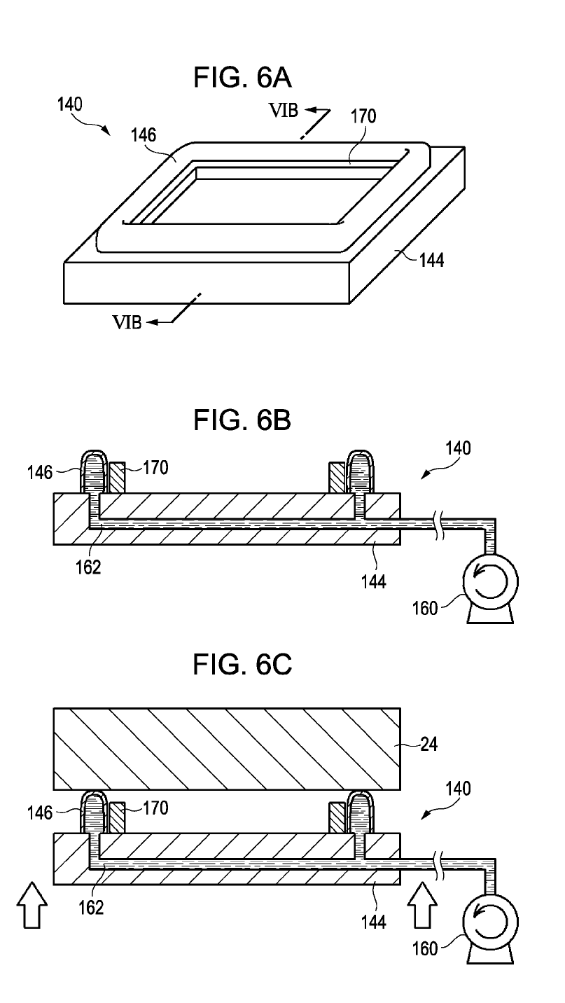

Although the embodiment described above includes the fluid bag 146 which is provided on top of the cap member 142, the invention is not necessarily limited to this. For example, the configuration shown in FIGS. 6A to 6C includes the fluid bag 146 disposed on the capping plate 144. The fluid bag 146 is of a tube structure made from a rubber member of a thin membrane shape and can hold a fluid in the interior thereof. Further, the interior of the fluid bag 146 is connected to the flow path 162 provided inside the capping plate 144, and the fluid can be supplied into the interior of the fluid bag 146 by driving the fluid driving pump 160 provided at the end of the flow path 162.

Further, the capping unit 140 according to this example includes a guard member 170 as the regulating member, which is provided on one side of the fluid bag 146 (in FIGS. 6A to 6C, inside), and the movement of the fluid bag 146 is regulated by the guard member 170, so that various disadvantages can be avoided. With regard to this point, description is made in detail below.

FIG. 6C is an explanatory view illustrating an aspect when the capping unit 140 according to this example has been pressed against the ejecting head 24. When the capping unit 140 is pushed up toward the ejecting head 24, the fluid bag 146 provided at the capping unit 140 comes into contact with the surface of the ejecting head 24, as shown in the drawing.

On the other hand, when the capping unit 140 is detached from the ejecting head 24, fluid in the fluid bag 146 is discharged by driving the fluid driving pump 160. Then, the fluid bag 146 shrinks and thus falls off from the surface of the ejecting head 24. Therefore, even in the case where the fluid bag 146 has been stuck to the surface of the ejecting head 24, the fluid bag 146 can be easily removed.

First of all, if fluid in the fluid bag 146 is discharged, since the fluid bag 146 becomes droopy and the hanging-down bag retracts into the cap, there are concerns about causing disadvantages such as the contamination of the fluid bag 146 with the ink in the cap, the contamination of the surface of the ejecting head 24 or the surrounding members with the fluid bag 146 contaminated with the ink, and the like. Thus, in the capping unit 140 according to this example, in order to avoid these situations, the guard member 170 is provided.

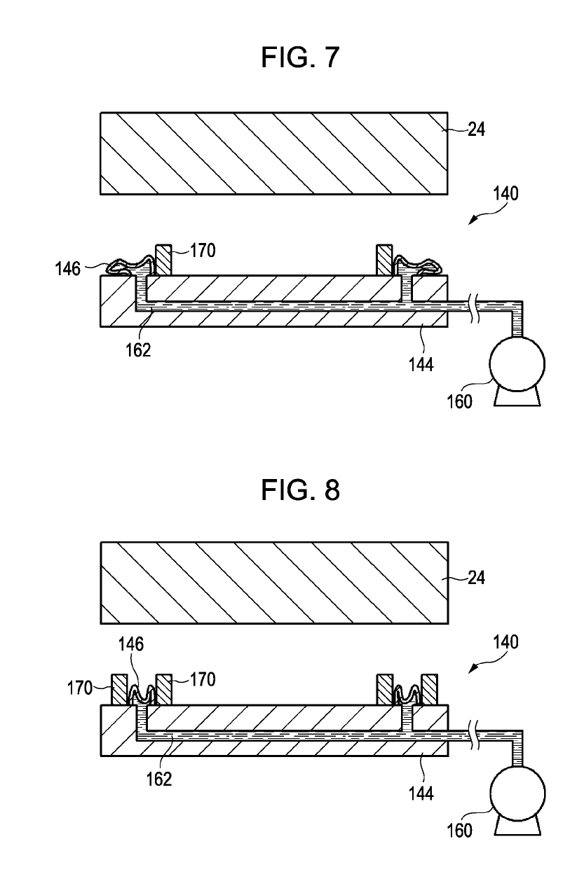

FIG. 7 is an explanatory view illustrating the aspect of using the guard member 170 to prevent a situation in which the fluid bag 146 goes into the cap. As shown in the drawing, the guard member 170 is provided adjacent to the inside (side near the center of the cap) of the fluid bag 146. If the fluid is discharged, and thus the fluid bag 146 hangs down, the hanging-down fluid bag tends to spread out laterally. However, since the guard member 170 is disposed inside (side near the center of the cap), the fluid bag 146 cannot spread inward. Therefore, a situation in which the fluid bag 146 enters the cap, and thus is contaminated with the ink in the cap can be avoided.

Also, since the fluid bag does not enter the cap, it is possible not only to avoid contamination with the ink, but also to sufficiently exert the function of a cap to more reliably prevent the drying of the ink in the ejecting nozzles. For example, when the cap is mounted, if the interior of the cap has dried, there are concerns that as the volatile component of the ink in the ejecting nozzles vaporize into the cap, the ink in the ejecting nozzles dries up. For this reason, in the ink jet printers, an operation may be performed which involves ejecting the ink into the cap to wet the interior of the cap. In this case, if the fluid bag remains drooping into the cap, a part of the ejected ink is interrupted by the fluid bag, so that the interior of the cap may not be sufficiently wetted. On the contrary, in the ink jet printer 10 according to this example, since the guard member 170 is provided, the fluid bag 146 does not droop into the cap, so that the interior of the cap can be sufficiently wetted, and therefore it becomes possible to more reliably prevent the drying of the ink in the ejecting nozzles.

Further, in the capping unit 140 according to this example, the fluid bag 146 can be pressed against the surface of the ejecting head 24 at a correct position by the guard member 170, so that the ejecting nozzles can be sealed more reliably. Namely, when the capping unit 140 is mounted, since there is a state in which the fluid has been supplied into the fluid bag 146 (referring to FIG. 6C) there are concerns that the fluid bag 146 inclines obliquely due to the weight of the fluid in the fluid bag 146, there may be shaking of the capping unit 140 when it is raised, or the like. Here, if the fluid bag 146 inclines inside the cap, the fluid bag 146 comes into contact with the inside portion of the surface of the ejecting head 24, so that there are concerns that the ejecting nozzles provided in the surface of the ejecting head 24 fail to be entirely covered by the cap. However, if the guard member 170 is provided, even if the fluid bag 146 inclines inward, the fluid bag 146 can be supported by the guard member 170, so that the fluid bag 146 can be brought into contact with the ejecting head at an appropriate position so as to reliably seal the ejecting nozzles.

Further, since various mechanisms such as a cam mechanism for driving the capping unit 140, the wiper blade 130, and the like are provided around the capping unit 140, if the fluid bag 146 droops outside the cap so as it comes into contact with these mechanisms, there are concerns that these mechanisms are contaminated with the ink, or the driving of them is impeded by the sticking of the fluid bag 146 to these mechanisms. In this case, the guard member 170 may also be provided not only inside the fluid bag 146, but also outside (side far from the center of the cap).

FIG. 8 is an explanatory view illustrating the capping unit 140 in which guard members 170 are provided on both the inside and the outside. As shown in the drawing, the guard members 170 are provided on both sides of the fluid bag 146 so that the fluid bag 146 is positioned between them. Also, the fluid bag 146 is provided to span between the guard members 170 disposed in parallel. Accordingly, it becomes also possible to avoid a situation in which the fluid bag 146 spreads outside the cap, thereby avoiding a situation in which there is a disadvantage that the fluid bag 146 comes in contact with the surrounding mechanisms.

Further, with this configuration, it becomes also possible to prevent a situation in which when the capping unit 140 is mounted, the fluid bag 146 inclines outward, and therefore it becomes also possible to more reliably seal the ejecting nozzles by bring the fluid bag 146 into contact with the ejecting head 24 at a more appropriate position.

As described above, in the ink jet printer 10 according to this example, the air-tightness of the cap is increased by reliably bring the capping unit 140 into close contact with the ejecting head 24 with the fluid bag 146 interposed between the capping unit 140 and the ejecting head 24. Therefore, the vaporizing of the ink from the ejecting nozzles can be reliably prevented, so that an image printable state can be maintained over a long period of time. Further, by providing the guard member(s) 170, it becomes possible to avoid a problem that when the fluid bag 146 has drooped, the fluid bag 146 goes into the cap, so that it is contaminated with the ink, and so on. In addition, by discharging fluid in the fluid bag 146, it is possible to easily remove the fluid bag 146 from the surface of the ejecting head 24, and also it becomes possible to quickly detach the mounted cap.

### Third Modified Example

In the example described above, the configuration was described in which the fluid bag and the guard member are of separate members. However, the fluid bag and the guard member may be integrated by adhesion or the like.

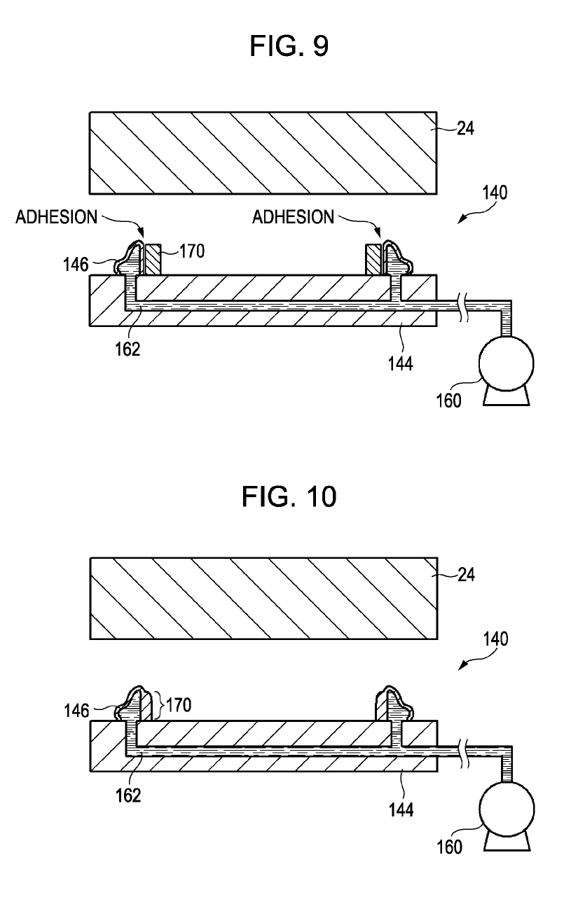

FIG. 9 is an explanatory view illustrating the capping unit in which the fluid bag and the guard member are integrated by adhesion. As shown in the drawing, one side face of the guard member 170 and one side face of the fluid bag 146 are adhered to each other. With this configuration, even if the fluid in the fluid bag 146 is discharged, the side face of the fluid bag 146 can remain as it is supported by the guard member 170, so that the fluid bag 146 does not hung down entirely. Therefore, it becomes possible to suppress the spreading out of the fluid bag to the side (in the example of FIG. 9, outside the cap) on which the guard member 170 is not provided. Further, with this configuration, it is possible to suppress the spreading out of the fluid bag even without providing the guard members on both sides of the fluid bag, so that the configuration of the capping unit 140 can also be kept simple.

Also, without integrating the fluid bag 146 and the guard member 170 by adhesion, they may be originally formed as an integral whole. For example, as shown in FIG. 10, the guard member 170 may be formed by thickening the rubber member of the fluid bag 146 at its side portion fixed to the capping plate 144. Even if the fluid in the fluid bag 146 is discharged, the thickened portion of the rubber member does not droop, so that the drooped portion of the fluid bag 146 can be prevented from spreading inside the cap by the thickened portion. Further, since one side of the fluid bag 146 is held by the guard member 170, the entire of the fluid bag 146 does not hung down completely, and therefore the spreading out of the fluid bag 146 can be suppressed also at the side which no having the guard member 170 provided. In addition, if the guard member 170 is formed in this manner, the guard member 170 can be provided only by changing the thickness of a portion of the fluid bag 146, and other members do not need to be provided separately. Therefore, the configuration of the capping unit 140 can be kept simple.

### Fourth Modified Example

In the example described above, the configuration was described in which the fluid bag is provided on the side of the guard member (referring to FIGS. 6A to 6C). However, the fluid bag may be provided on top of the guard members.

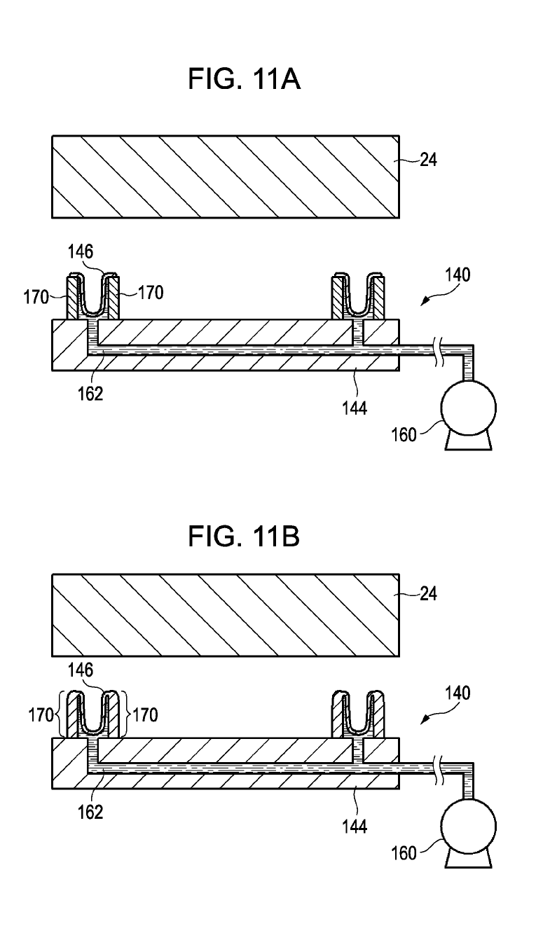

FIGS. 11A and 11B are explanatory views illustrating the capping unit in which the fluid bag is provided on top of the guard members. In an example shown in FIG. 11A, the guard members 170 are disposed on both sides of the flow path 162 and the fluid bag 146 is provided to span between two guard members 170. When the fluid is fed from the flow path 162, the fluid can be supplied into the fluid bag 146 through between two guard members 170. Therefore, even with this configuration, it is possible to press the fluid bag against the ejecting head 24 in a state where fluid is supplied into the fluid bag 146. Further, as shown in the drawing, in a state in which the fluid has been discharged, the fluid bag 146 can be housed between two guard members 170, and therefore it becomes possible to avoid a situation in which the fluid bag 146 collapses, and then spreads out laterally.

Further, since the space between two guard members 170 becomes a flow path for the fluid, when the fluid in the fluid bag 146 is discharged, the fluid bag 146 is pulled by the fluid, thereby being drawn into between two guard members 170. For this reason, although the fluid bag 146 has fallen laterally and has gone past the guard member 170, if the fluid is discharged, the fluid bag 146 can be drawn into and housed between the guard members 170. Therefore, it becomes possible to reliably avoid a situation in which the fluid bag 146 spreads out laterally.

Further, since the fluid bag 146 can be drawn into and reliably housed between the guard members 170, the fluid bag 146 can also be formed to be larger. If the fluid bag 146 is formed to be larger, when the fluid has been fed, the fluid bag 146 can be pushed out higher toward the ejecting head 24. Accordingly, even if the capping unit 140 is not raised much, the fluid bag 146 can be brought into contact with the ejecting head 24 by feeding fluid, and therefore it becomes also possible to further simplify the driving mechanism of the capping unit 140.

Further, as shown in FIG. 11B, the guard members 170 may be provided by thickening the side portions of the rubber member of the fluid bag 146. Since the thickened portions of the fluid bag 146 do not droop even when the fluid is discharged, also in this case, the fluid bag 146 can be housed between the guard members 170.

### Fifth Modified Example

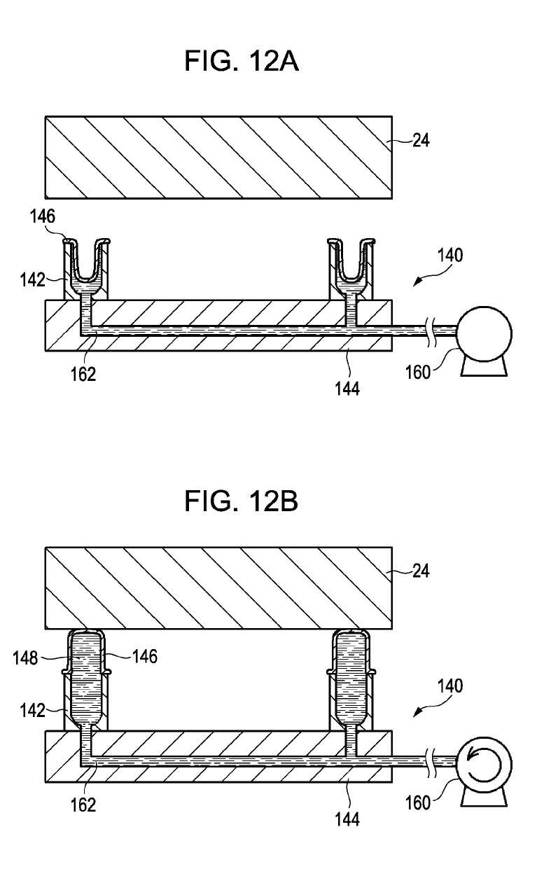

Also, a receiving groove may be provided in the cap member so that the fluid bag is housed in the receiving groove when the fluid is not injected into the fluid bag. For example, as shown in FIG. 12A, if the receiving groove is provided by drilling the center of the cap member 142, when the fluid has not been injected, the fluid bag 146 naturally droops into the receiving groove, so that it can be put in the receiving groove. Therefore, since the fluid bag 146 does not droop into the cap, it becomes possible to avoid situations in which the drooped fluid bag 146 is contaminated with the ink in the cap, and the surface of the ejecting head 24 or the surrounding members are contaminated with the fluid bag 146 with the ink attached.

Also, with this configuration, it becomes also possible to use a larger fluid bag. In this case, when the fluid has been injected, the fluid bag can rise higher toward the ejecting head, and therefore even without greatly driving the capping unit itself, the fluid bag can be brought into close contact with the ejecting head. Therefore, the driving mechanism of the cap can be simplified or omitted.

### Sixth Modified Example

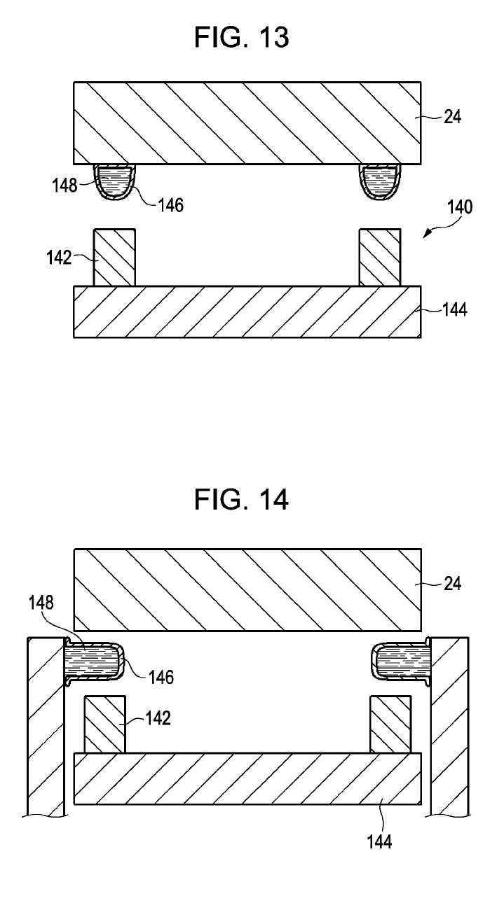

In the example described above, the configuration was described in which the fluid bag is provided on the surface of the cap member. However, the fluid bag may also be provided on the surface of the ejecting head, instead of the cap member. For example, as shown in FIG. 13, the fluid bag 146 may also be provided at a position on the surface of the ejecting head 24, where the cap member 142 comes into contact. With this configuration, since the fluid bag 146 and the cap member 142 can come into close contact with each other without leaving a gap by using the rising of the capping unit 140, the air-tightness in the cap can be increased.

Otherwise, the fluid bag may also be provided on a member other than the cap member or the ejecting head. For example, as shown in FIG. 14, the fluid bag 146 may also be held on a pillar-shaped member provided around the capping unit 140.

In a case where the fluid bag is provided on either the cap member or the ejecting head, simply, the fluid bag may be bonded thereto by an adhesive agent or the like. First of all, for any reason, there are concerns that the adhesive agent cannot sufficiently fill between the member and the fluid bag, or that the air-tightness of the cap is lowered due to a minute gap which is formed at the joined portion between the fluid bag and the member when the adhesive agent has been deteriorated after the lapse of a long period of time since manufacture. Therefore, in the configuration arranged such that the fluid bag 146 remains fixed to any other member, and thereafter it is brought into close contact with the ejecting head 24 and the cap member 142, it becomes possible to avoid concerns that the air-tightness of the cap will be lowered due to the gap between such joined surfaces, and thus to more reliably increase the air-tightness of the cap.

Heretofore, the liquid ejecting apparatus has been described according to the embodiment and the modified examples, but the invention is not to be limited to them, but can be implemented in various aspects within the scope that do not depart from the essential points thereof. For example, the invention can also be applied to a printing apparatus (a so-called line head printer, etc.) having a larger ejecting head. In case of such a printing apparatus, where the ejecting head is made larger, the wave-shaped portions are apt to be formed in the surface of the ejecting head. However, if the fluid bag is interposed between the cap member and the ejecting head, it becomes possible to bring the cap member into close contact with the ejecting head even if the wave-shaped portions exist. Further, as the ejecting head is made larger, there are concerns that the fluid bag is apt to droop. However, if the guard member is provided, it becomes possible to avoid a situation such as the retracting of the hanging-down fluid bag into the cap. Therefore, even in cases of a larger ejecting head, it becomes possible to increase the air-tightness of the cap, and consequently to prevent the evaporation of the ink by the sure sealing of the ejecting nozzles, or reliably restoring the ejecting nozzles by performing the cleaning operation.

What is claimed is:

1. A liquid ejecting apparatus for ejecting a liquid by using a liquid ejecting head provided with nozzles, the apparatus comprising:
a cap capable of being mounted on the liquid ejecting head,
wherein the cap includes a seal member which comes into close contact with the liquid ejecting head when the cap is mounted on the ejecting head, and
the seal member is a member which is in a state where fluid is supplied in the interior thereof at least when the cap is mounted.

2. The liquid ejecting apparatus according to claim 1, further comprising:
a fluid feeder which supplies the fluid into the interior of the seal member when the cap is mounted.

3. The liquid ejecting apparatus according to claim 2, further comprising:
a fluid discharger which discharges the fluid in the interior of the seal member when the cap is detached.

4. A liquid ejecting apparatus for ejecting a liquid by using a liquid ejecting head provided with nozzles, the apparatus comprising:
a cap capable of being mounted on the liquid ejecting head;
a seal member disposed on the side of the cap facing the liquid ejecting head;
a fluid feeder which supplies the fluid into the seal member at least when the cap is mounted; and
a regulating member which is provided on the cap on the side of the seal member so as to regulate the entering of the seal member.

5. The liquid ejecting apparatus according to claim 4, wherein the regulating member is a member which is provided on the inner side in comparison to where the seal member is disposed on the cap.

6. The liquid ejecting apparatus according to claim 4, wherein the regulating member is a member which is provided on the outer side in comparison to where the seal member is disposed on the cap.

7. The liquid ejecting apparatus according to claim 4, wherein the regulating member includes members which are provided in parallel on both sides in relation to where the seal member is disposed on the cap, and
the seal member is provided to span between the regulating members disposed in parallel.

8. The liquid ejecting apparatus according to claim 4, wherein the regulating member is a member formed integrally with the seal member.
